(19) United States
(12) Patent Application Publication
(10) Pub. No.: US 2002/0038166 A1
(43) Pub. Date: Mar. 28, 2002

(54) Self serve apparatus for processing the return of library materials

(75) Inventor: Egon Valter Kublick, Ballerup (DK)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: CODECO APS

(21) Appl. No.: 09/810,316

(22) Filed: Mar. 14, 2001

(30) Foreign Application Priority Data
Mar. 31, 2000 (CA) 2,303,632

(51) Int. Cl. G06F 7/00

(52) U.S. Cl. 700/225

(57) ABSTRACT

A self serve apparatus for processing the return of library materials which includes a body with a passage for receiving library materials extending through the body. The passage has an inlet end and an outlet end. Library materials are conveyed along the passage from the inlet end to the outlet end. A user identification input device is provided on the body, whereby a user is identified. A library material identification reader is provided for receiving article information from library material as it passes along the passage from the inlet to the outlet.

### FIELD OF THE INVENTION

The present invention relates to a self serve apparatus for processing the return of library materials.

### BACKGROUND OF THE INVENTION

U.S. Pat. No. 5,777,884 held by Minnesota Mining and Manufacturing Company is representative of the state of the art relating to article inventory tracking and control systems. When these systems were first introduced into public libraries, they were operated solely by library staff.

In an effort to reduce overall staffing costs, there has been a movement to self service apparatus to process library materials. Minnesota Mining and Manufacturing Company has a self service unit identified in sales literature by the Trade Mark “6210 Self Check Unit”. CODECO APS of Denmark has a competitive self service unit sold under the Trade Mark “MARK 3”. These machines are capable of facilitating the check out of library materials, but are incapable of facilitating the return of library materials.

### SUMMARY OF THE INVENTION

What is required is a self serve apparatus for processing the return of library materials.

According to the present invention there is provided a self serve apparatus for processing the return of library materials which includes a body with a passage for receiving library materials extending through the body. The passage has an inlet end and an outlet end. Means is provided for conveying library materials along the passage from the inlet end to the outlet end. A user identification input device is provided on the body, whereby a user is identified. A library material identification reader is provided for receiving article information from library material as it passes along the passage from the inlet to the outlet.

The invention, as described above, provides a workable self serve apparatus for returning materials. Further features can be added to enhance the operation of this basic device, as will hereinafter be further described.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a self serve apparatus for processing the return of library materials constructed in accordance with the teachings of the present invention.

FIG. 2 is a perspective view of the self serve apparatus illustrated in FIG. 1.

FIG. 3 is a perspective view of the self serve apparatus illustrated in FIG. 1.

FIG. 4 is a perspective view of the self serve apparatus illustrated in FIG. 1.

FIG. 5 is a perspective view of the self serve apparatus illustrated in FIG. 1.

FIG. 6 is a perspective view of the self serve apparatus illustrated in FIG. 1.

FIG. 7 is a perspective view of the self serve apparatus illustrated in FIG. 1.

### DETAILED DESCRIPTION OF THE PREFERRED EMBODIMENT

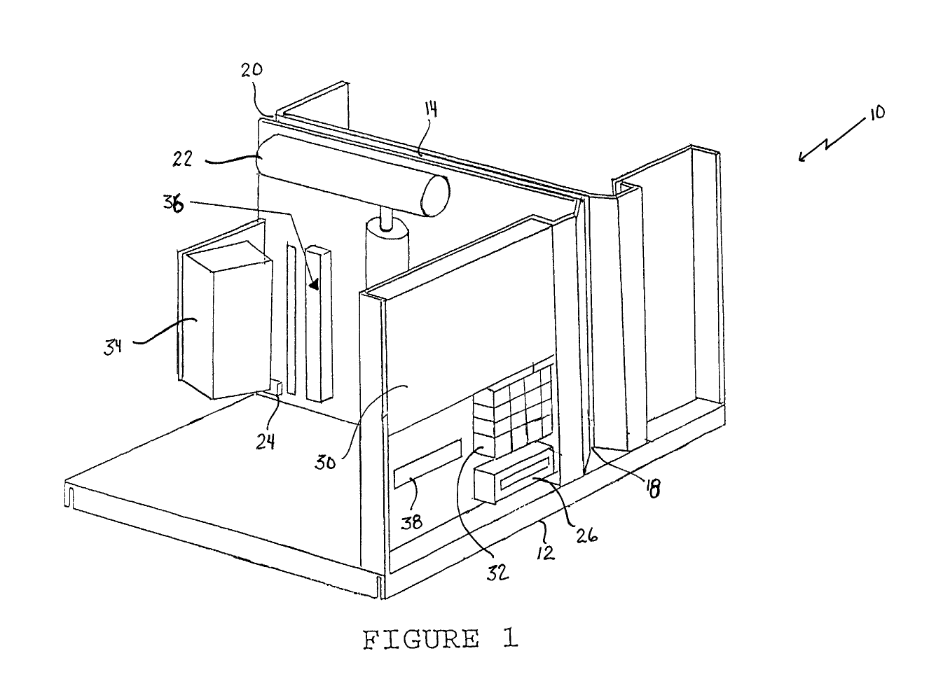

The preferred embodiment, a self serve apparatus for processing the return of library materials generally referenced by the numeral 10 will now be described with reference to FIGS. 1 through 7.

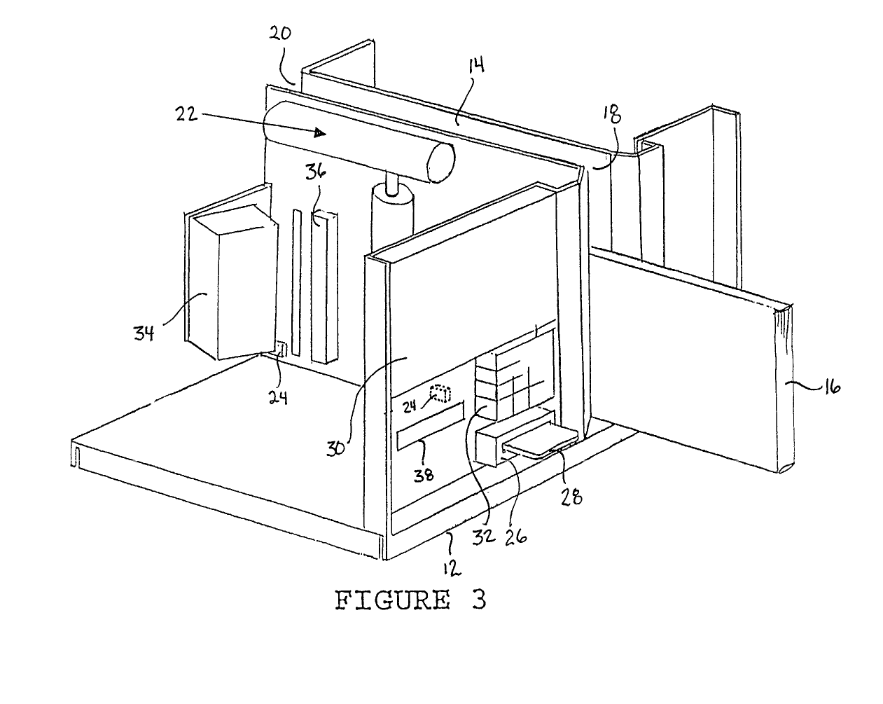

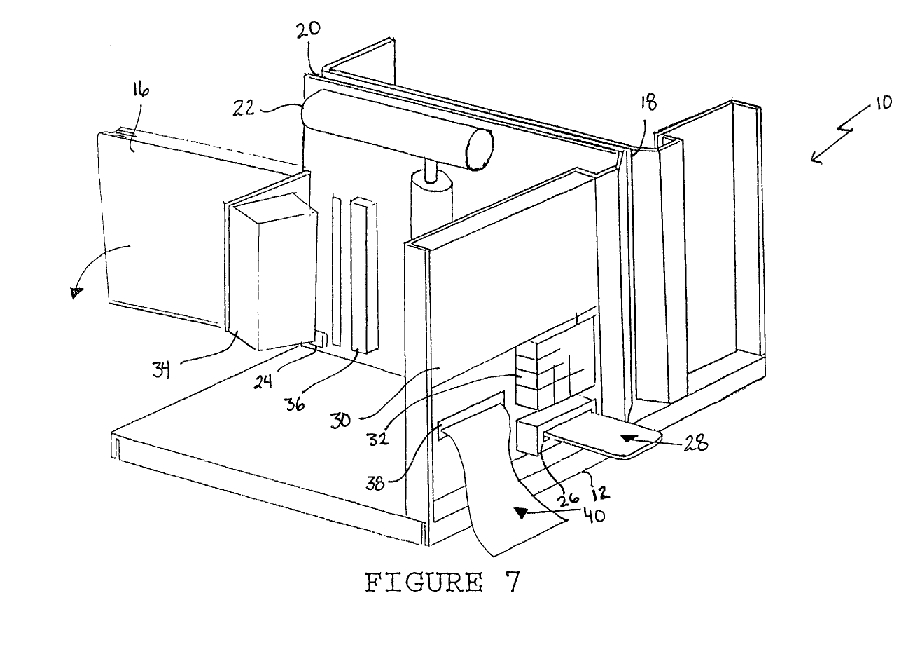

Referring to FIGS. 1 and 3, there is provided a self serve apparatus 10 for processing the return of library materials which includes a body 12 with a passage 14 for receiving library materials 16 extending through body 12. Passage 14 has an inlet end 18 and an outlet end 20. A motor assembly 22 is provided to convey library materials 16 along passage 14 from inlet end 18 to outlet end 20. It will be appreciated that other means are available to convey library material 16 through passage 14. Referring to FIG. 3, sensors 24 are provided along passage 14 which sense when library materials 16 have been placed in inlet end 18 of passage 14. Sensors 24 then signal and activate motor assembly 22 to convey library material 16 toward outlet end 20 of passage 14 and deactivate motor assembly 22 after library materials 16 have exited passage 14 through outlet end 20. Referring to FIG. 7, outlet end 20 of passage 14 discharges library materials 16 into a security enclosure to which the public does not have access.

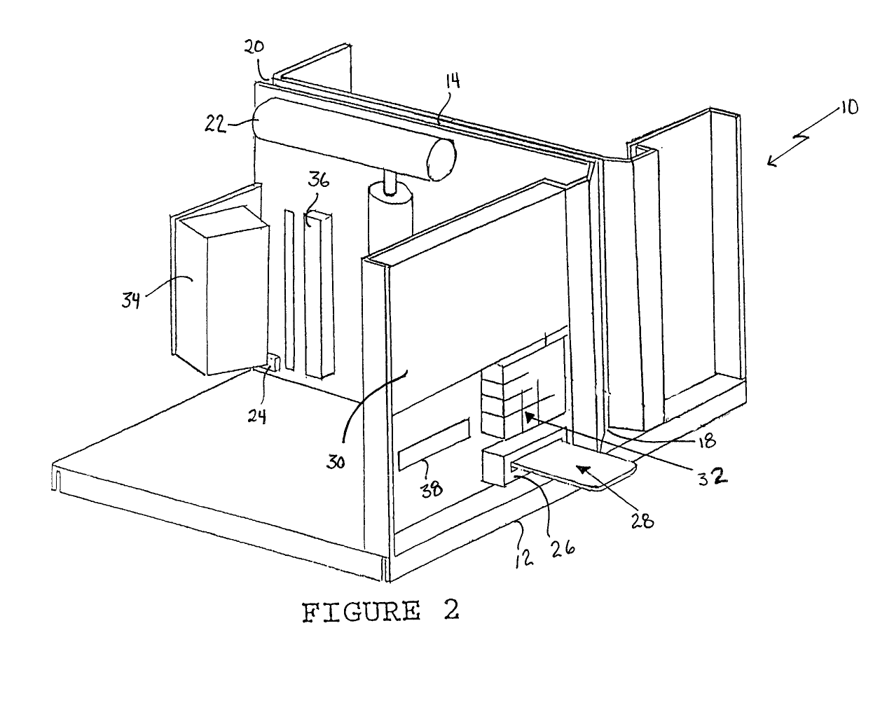

Referring to FIG. 2, a user identification input device 26 is provided on body 12, whereby a user is identified. In the illustrated embodiment, user identification input device 26 is card reader which is adapted to read assorted types of patron cards 28 such as read magnetic cards, barcode cards, chip cards and RFID cards.

A display screen 30 and a function input device 32 are also provided on body 12 so that a user can view the function options on the display screen 30 and then enter the corresponding function choice in function input device 32. In the illustrated embodiment, function input device 32 is a numeric keyboard however it will be appreciated that other input devices could also function.

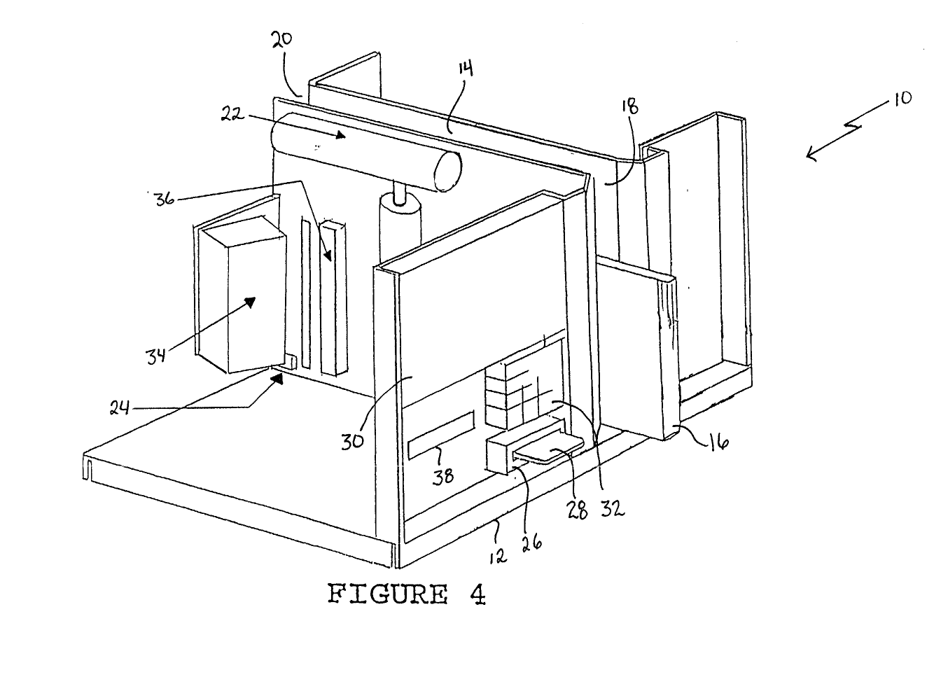

Referring to FIG. 4, a library material identification reader 34 is provided on body 12 for receiving article information from library material 16 as library material 16 passes along passage 14 from inlet end 18 to outlet end 20. In the illustrated embodiment, library materials identification reader 34 is a bar code scanner that reads a bar code positioned on an exterior surface of library materials 16 however, it will be appreciated that library identification reader 34 could also be a radio frequency identification tag reader that reads a radio frequency identification tag positioned within library materials 16.

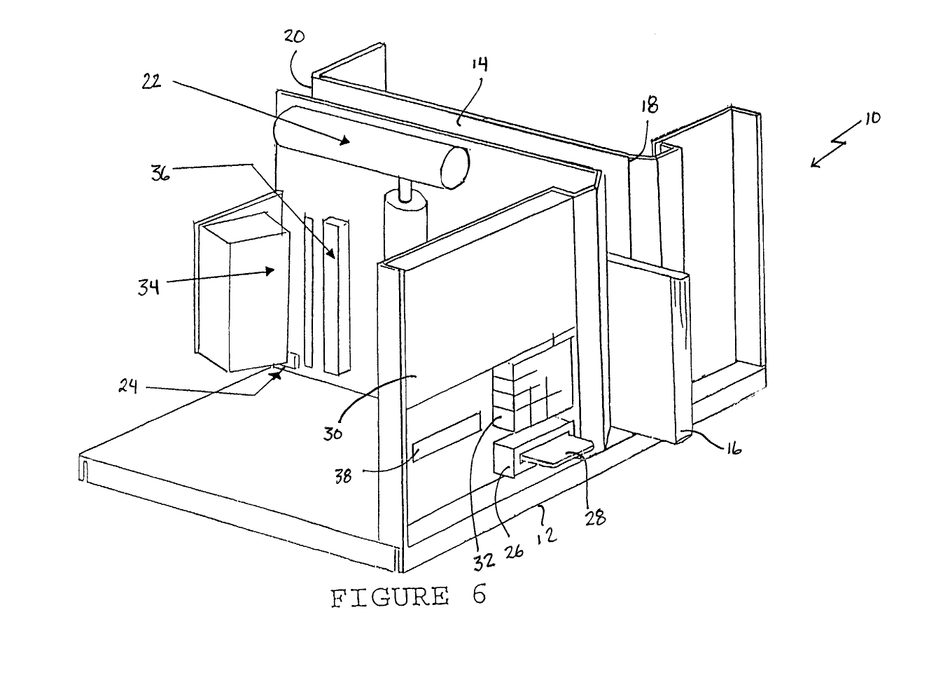

Referring to FIG. 6, a sensitizing device 36 is also provided on body 12 for desensitizing and resensitizing anti-theft devices imbedded in library material 16 as library material 16 passes along passage 14.

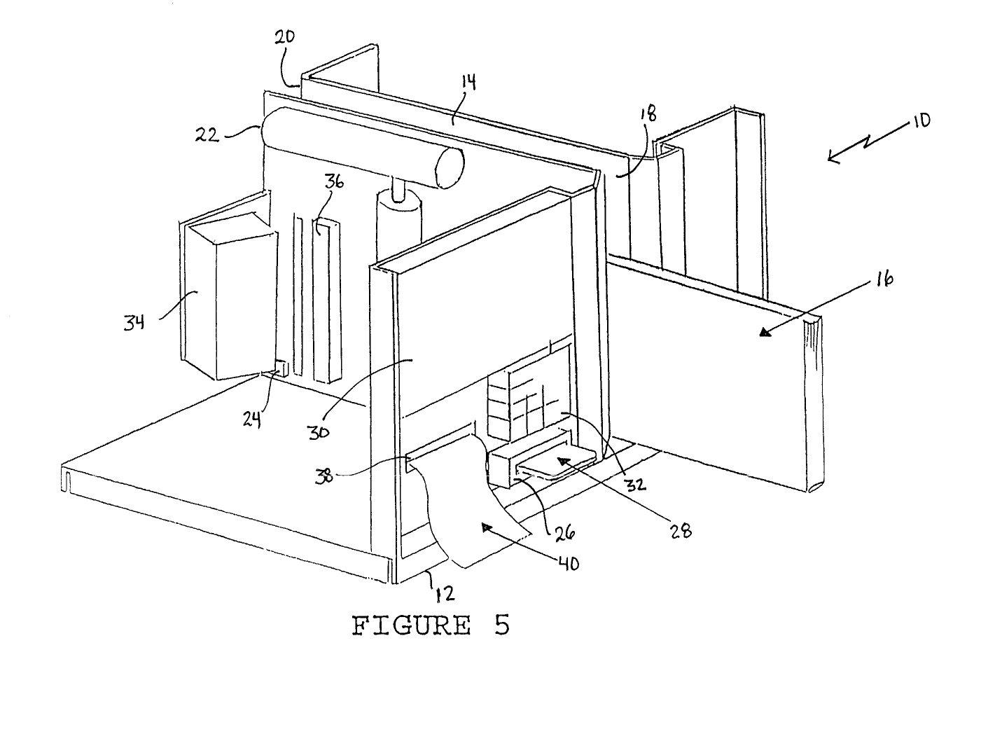

Referring to FIGS. 5 and 7, body 12 includes a receipt printer 38, whereby a user is provided with written confirmation 40 that library materials 16 have been returned or properly checked out. Receipt printer 38 can also be used to print out other information such as accumulated late fees and library hours.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. Introduction

The Mark-4 system is to be used in libraries for performing self-service for clients when returning materials to the library or can be used as a borrowing system also.

Unique identification of materials is based on a barcode label, which must be located on the outside of the material Furthermore the system is able to handle the security alarm strip placed behind the barcode label or hidden somewhere in the material (usually the spine)

During the lending the alarm strip will be turned off(de-sensitised) and during returning of materials, the alarm strip will be turned on (re-sensitised).

The system is capable of handling the following type of materials- as long as the barcode is placed will on the out-side:

Books (with or without alarm strip)

CD's (with or without alarm strips)

Video cassettes (with or without alarm strips)

Audio cassettes (with or without alarm strips)

2. System design

The electronic functions in the Mark-4 system include:

Barcode scanner

Card reader device

Pin-code keyboard

Function keyboard

Receipt printer

Flat screen monitor

Motor assembly

Re/de sensitising coils

Optical sensors

In addition to this, the system includes a mechanical parallel moving metal plate giving clearance for entering materials in a vertical slot.

All items in use are interfaced to a standard PC which will perform the individually tasks as described in the following sections.

Component description:

| | |
|---|---|
| Barcode scanner: | The barcode scanner can be of the fabrication |
| | Microscan type MS 710, Sick type CLV 432-0010S01 |
| | or Datalogic type 4300 and type 2100 The choice |
| | depends on the requirement from the library such as: |
| | size of barcode label, barcode type, and barcode |
| | colour, reading distance, reading angle. |
| Receipt printer | In the design a Citizen printer type CBM 1000 is |
| | included. This accommodates the paper receipt to exit |
| | vertically Other printers may be used on special |
| | request from libraries. |
| Card reader | A wide range of readers will be used for the Mark-4 |
| | so it can be customised for each library client requiring |
| | the following patron cards |
| | Magnetic cards (1/2/3 tracks) |
| | Barcode cards |
| | Chip cards |
| | RFID cards |
| | The system card reader can be either motorised or |
| | manually operating |
| Flat screen: | A 10 5″ TIT flat screen is used to provide the client |
| | with the necessary procedural information during |
| | lending or returning operation |
| Reminding arts | Codeco will develop all the functionalities, such as: |
| | keyboards, sensors, sensitising coils, motor assembly |
| | and circuitry for performing the movement |

3. Step by step Borrowing session

a) The client defines the required operation by pressing the function button named, (borrow).

b) The client enters his patron card into the card reader slot.

c) When accepted, the system will request for entering a four digit pincode.

d) Client enters pincode by activating the numeric key pad (0-9).

e) On acceptance client may start registration of materials.

f) Client places first material item in the V- shaped vertical slot at the front of the unit.

g) By entering the material in the slot, between the two V-formed plates, an opening will appear- just enough for the material to pass between the plates. The rightmost plate is spring supported and will move to the right when pressure activated, accommodating various book sizes

h) When the material is entered to the point that the optical sensor “notices” the material, a motorized meganism will take over the movement, and assist further guidence of the material.

i) This forward movement will accomodate the barcode on the material to apear at the scanner opening.

j) The scanner will read the barcode while it is passing by the laserbeam.

k) When the furthest sensors signals the arrival of the material, the movement will stop.

l) Registration based on barcode and approval will now take place in the libraries computer circulation system.

m) An acknowledgement will now cause the motor to turn in opposite direction. Simultaneously, the power is switched on for the deactivating coil.

n) While the material in its reverse movement passes by the deactivator coil, the alarmstrip hidden in the material will be neutralised.

o) The on-going reverse movement will stop as soon as the front positioned sensor sees the material has passed by

p) Now the material is located in the same posit on as at the start of the procedure

q) The client removes the material and the system is ready for registration of the next item

r) The same procedure will take place for the remaining materials, as listed in item f-q

s) Finally when the registration is finished, the client removes his/her patron card from the cardreader slot.

t) The system will generate a listing of all registrated materials as a receipt on the receipt printer.

u) The borrowing session is terminated and the system is ready for next client

End of Borrowing session

4. Step by step Return session

a) The client defines the required operation by pressing the function button named (return).

b) The client enters his patron card into the cardreader slot.

c) When accepted, the system will request for entering a four digit pincode

d) Client enters pincode by activating the numeric key pad (0-9)

e) On acceptance client may start registration of materials

(Item c, d and e may be omitted to customize function for the library)

f) Client places first material item in the V- shaped vertical slot at the front of the unit

g) By entering the material in the slot, between the two V-formed plates, an opening will appear-just enough for the material to pass between the plates. The rightmost plate is spring supported and will move to the right when pressure activated, accomodating various book sizes.

h) When the material is entered to the point that the optical sensor “notices” the material, a motorized meganism will take over the movement, and assist further guidence of the material.

i) This forward movement will accomodate the barcode on the material to apear at the scanner opening.

j) he scanner will read the barcode while it is passing by the laserbeam.

k) When the furthest sensors signals the arrival of the material, the movement will stop

l) Registration based on barcode and approval will now take place in the libraries computer system.

m) Based on the information reply from the library circulation system, the reactivation coil will be turned on, causing the hidden alarm strip in the material to be activated.

n) An acknowledgement will cause the motor to turn on again and continue the material movement further into the system. Simultaneously an exit selector will decide an sorting option for the material.

o) The on-going movement into the system will stop as soon as furthest sensors signals the arrival of the material, and turned off the power supply for the reactivation coil

p) The material will now slide out of the machine into the selected containers

q) One of the containers will have returned materials that can immediate be placed on the shelfs of the library. The other container holds all other materials which are either on holds or belong to other branches/libraries.

r) The same procedure will take place for the remaining materials, as listed in item f-q

s) Finally when the registration is finished, the client removes his patron card from the cardreader slot.

t) The system will generate a receipt, listing all returned materials and possibly accumilated late fees

u) The return session is terminated and the system is ready for next client

End of Return session

The embodiment of the invention in which an exclusive property or privilege is claimed are defined as follows:

1. A self serve apparatus for processing the return of library materials, comprising:
a body;
a passage for receiving library materials extending through the body, the passage having an inlet end and an outlet end;
means for conveying library materials along the passage from the inlet end to the outlet end;
a user identification input device on the body, whereby a user is identified; and
a library material identification reader for receiving article information from library material as it passes along the passage from the inlet to the outlet.

2. The self serve apparatus as defined in claim 1, wherein a data link is provided to a computer system of a library.

3. The self serve apparatus as defined in claim 1, wherein means is provided for resensitizing anti-theft devices imbedded in the library material as it passes along the passage.

4. The self serve apparatus as defined in claim 1, wherein the library materials identification reader is a bar code scanner that reads a bar code positioned on an exterior surface of the library materials.

5. The self serve apparatus as defined in claim 1, wherein the library materials identification reader is a radio frequency identification tag reader that reads a radio frequency identification tag positioned within the library materials.

6. The self serve apparatus as defined in claim 1, wherein the body has a electronic card payment capacity to process late return charges.

7. The self serve apparatus as defined in claim 1, wherein the outlet end of the passage discharges into a security enclosure to which the public does not have access.

8. The self serve apparatus as defined in claim 1, wherein the body include a receipt printer, whereby a user is provided with written confirmation that the library materials have been returned.

9. A self serve apparatus for processing the return of library materials, comprising:
a body;
a passage for receiving library materials extending through the body, the passage having an inlet end and an outlet end;
a conveyor for conveying library materials along the passage from the inlet end to the outlet end;
a user identification input device on the body, whereby a user is identified;
a library material identification reader for receiving article information from library material as it passes along the passage from the inlet to the outlet;
a security module for resensitizing anti-theft devices imbedded in the library material as it passes along the passage;
a data link from the library material identification reader to a computer system of a library, whereby records in the computer system of the library are updated;
the outlet end of the passage discharging into a security enclosure to which the public does not have access; and
a receipt printer, whereby a user is provided with written confirmation that the library materials have been returned.

10. The self serve apparatus as defined in claim 9, wherein the library materials identification reader is a bar code scanner that reads a bar code positioned on an exterior surface of the library materials.

11. The self serve apparatus as defined in claim 9, wherein the library materials identification reader is a radio frequency identification tag reader that reads a radio frequency identification tag positioned within the library materials.

12. The self serve apparatus as defined in claim 9, wherein the body has a electronic card payment capacity to process late return charges.
